(19) United States
(12) Patent Application Publication
(10) Pub. No.: US 2012/0173251 A1
(43) Pub. Date: Jul. 5, 2012

(54) METHOD AND APPARATUS FOR ENROLLING A CUSTOMER IN A SERVICE WHILE PROVIDING LIMITED REQUIRED PERSONAL INFORMATION

(75) Inventor: Matthew J. Gillin, Villanova, PA (US)

(73) Assignee: RELAY HOLDINGS, LLC, Radnor, PA (US)

(21) Appl. No.: 12/983,773

(22) Filed: Jan. 3, 2011

(51) Int. Cl. G06Q 30/00

(52) U.S. Cl. 705/1.1

(57) ABSTRACT

A customer is invited to enroll in a service offered by an entity by linking an invitation to enroll in the service with a customer's mobile phone number either before (when the customer's mobile phone number is known in advance) or after an enrollment is initiated from the customer's mobile phone number (the invitation response is matched to the customer after having been sent). Typically, the enrollment includes a simple request to activate their enrollment from their mobile phone (call/text). The customer's response to the enrollment from the mobile phone is logged, matched with a confidence score, and captured as a record of the customer's enrollment in the service. Enrollment services with the customer may proceed once the customer is enrolled.

### CROSS-REFERENCE TO RELATED APPLICATIONS

The present application is related by subject matter to the invention described in U.S. patent application Ser. No. 12/831,486, filed Jul. 7, 2010. The subject matter of that application is hereby incorporated by reference in its entirety.

### TECHNICAL FIELD

The present disclosure relates to an electronic communication system and method and, more particularly, to a system and method for enrolling a customer in a service by linking the customer's mobile phone number to an existing service account whereby limited personal information is required from the customer to enroll in the service. The linking may be performed before the invitation is sent or after a response is received.

### BACKGROUND

Many businesses would like to enroll their customers in new services but are unable to do so cost-effectively because they use a two-step opt-in process that is cumbersome, requiring the customer to provide personally identifiable information. For example, a utility company may wish to increase the adoption of paperless bills; however, the utility company does not have electronic contact information for its customers, so they resort to traditional marketing channels (statements, mailers, radio, web) to ask customers to go paperless. In order to go paperless, the customer must either mail a form back, call the utility company or log on to the utility company's web site. All of these channels require the customer to provide personally identifiable information before the go paperless enrollment can be confirmed.

To address this issue, some businesses have attempted to gather electronic contact information for their customers by allowing their customers to create electronic accounts, by contacting their customers to request electronic contact information, or by requiring their customers to provide electronic contact information. Unfortunately, such efforts may require a lot of time and money and may not produce the desired results. Furthermore, such efforts require active participation of customers who may not have the time, desire or incentive to provide the requested electronic contact information.

These issues have been addressed by a system described in U.S. patent application Ser. No. 12/831,486, filed Jul. 7, 2010. In the system described therein, a customer's phone number is passively acquired using a unique code and a proxy code that is created for each customer. The proxy code is sent to the customer with an invitation to open a new account, receive a new service, or renew a service by returning the proxy code by phone call or SMS text message. The proxy code is received from the customer by phone call or text message and the number is linked to the unique code using the proxy code. However, this approach does not allow a company to best leverage the information it already has in its customer accounts to provide a way for a consumer to enroll in a service without providing a proxy code. This approach further does not establish the customer's willingness to accept the new service with a simple yes/no response prior to sending a separate invitation to enroll in the service.

In addition, when a customer enrolls in a new service, such as agreeing to accept bills via SMS text message, a record of the customer's agreement to accept the new service needs to be kept. It is desired to establish such records with minimal effort on the part of the customer.

A technique is desired that would address the above-mentioned needs in the art by allowing a company to leverage its customer account information to send invitations to enroll in services to its customers that the customers may accept with minimal effort and by providing minimal information (e.g., enrollment by a “yes” response to an enrollment request). The present invention addresses these needs in the art.

### SUMMARY

Disclosed herein are systems and methods for enrolling a customer in a service offered by an entity (e.g., a credit card activation) while addressing the above-mentioned needs in the art. In accordance with the method of the invention, an invitation to enroll in a service offered by the entity is sent to the customer via mail, radio, bill board, phone, email, text, web, and the like. The invitation to enroll may be pre-linked with a customer's mobile phone before the invitation is sent or post-linked with the customer's mobile phone after a response is received. Typically, the invitation to enroll includes a simple request to activate a service. The customer can then enroll in the service by calling or texting from their mobile phone or going to a website. The customer's response to the invitation is captured as a record of the customer's enrollment in the service. In an exemplary embodiment, an invitation could be a free to end user SMS text message, whereby no cost is incurred by the customer for receiving the text message.

In an exemplary embodiment, the text message includes an invitation to enroll in the service that is pre-linked to the customer's mobile phone number, and the text message elicits a yes or no confirmation response from the customer to enroll in the service. The customer's mobile phone number is pre-linked to the invitation to enroll in the service by receiving customer data from a client offering the service, capturing or determining the customer's mobile phone number from the customer data, and matching the captured or determined mobile phone number to a customer account of the customer. Once the customer's mobile number is so linked to the customer account, the invitation to enroll in the service is prepared by preparing a list of invitees for the invitation from the customer data provided by the entity and providing a unique identifier for each invitation to be sent to each invitee.

In the exemplary embodiment, capturing the customer's response includes logging the customer's response to the text message into a database with the customer's mobile phone number. A report to the entity may also be prepared indicating which customers have agreed to communicate with the entity using SMS text messaging. In this fashion, no proxy code needs to be generated by the entity and returned to the entity by the customer in order to initiate a marketing campaign.

In another exemplary embodiment, the invitation is sent to customers using mobile phone numbers that are not linked to the invitation in advance. Instead, the customer's response to the text message is linked to the customer's accounts with the entity by identifying the customer who responded to the text message and linking the responding customer to the customer's accounts with the entity. As in the pre-linking embodiment, the customer's response to the text message is then logged into the database with the customer's mobile phone number.

In another exemplary embodiment, the invitation is marketed to existing customers on a bill board or some other public display such as a kiosk or website. Upon seeing the advertisement, an existing customer texts “yes” to a short code. The customer's text message is received, logged and processed for enrollment. During the enrollment process, several steps occur to match the customer initiating the enrollment to the correct account at the client without requiring personal information. For example, a confidence score may be generated by determining the owner of the mobile number and then matching that owner to the information in the client account holder file. In order to increase the confidence score, other sources of information may be gathered by hitting 3^{rd} party databases, requesting more information from the client, or in some cases asking the customer to provide additional information. Once a sufficient confidence score is reached, a confirmation is provided to the customer and the enrollment is then logged into the database with the customer's mobile phone number.

A communications platform may be programmed to implement the invitation services described herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Exemplary embodiments of the invention will be described in connection with the associated figures, of which:

FIG. 1 illustrates an example embodiment of a system for enabling customers to enroll in a new service while providing limited personal information.

FIG. 2 illustrates an example embodiment of a method for inviting customers to enroll in a new service where the customer's mobile phone number is pre-linked to the customer's account information.

FIG. 3 illustrates an example embodiment of a method for inviting customers to enroll in a new service where the customer's mobile phone number is not known in advance and is linked to the customer's account information after the customer has replied to the service invitation.

FIG. 4 illustrates an example embodiment of a system for enabling customers to enroll in a new service while providing limited personal information by pre-linking and/or post-linking the customer's mobile phone number to the customer's account information.

FIG. 5 illustrates an example embodiment of the enrollment and mobile activation of an account card whereby the card holder information is pre-linked, but does not include the card holder's mobile number.

### DETAILED DESCRIPTION OF ILLUSTRATIVE EMBODIMENTS

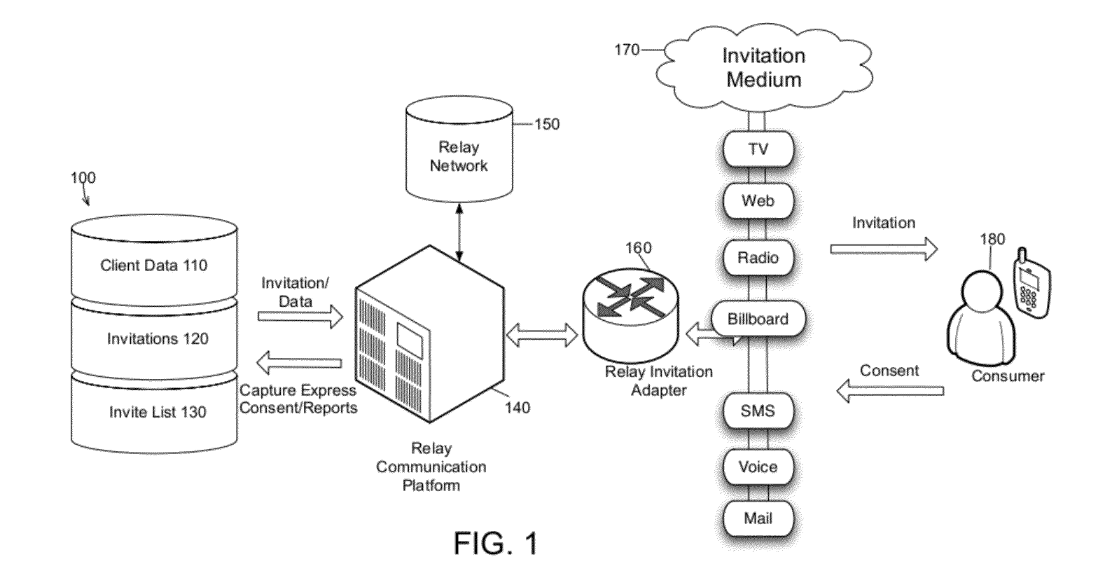

A detailed description of illustrative embodiments of the present invention will now be described with reference to FIGS. 1-5. Although this description provides a detailed example of possible implementations of the present invention, it should be noted that these details are intended to be exemplary and in no way delimit the scope of the invention.

Disclosed herein are systems and methods of inviting a customer to enroll in a service offered by an entity by linking the customer's mobile phone number to an invitation and accepting a YES/NO response or other non-personal information linked or linkable to the customer's mobile phone number including the invitation for enrolling in the offered service.

FIG. 1 illustrates an example embodiment of such a system for inviting customers to enroll in a new service. This system may be used, for example, to acquire a customer's permission to activate a new account, such as a credit card; activate a new service, such as electronic billing; or renew a service, such as renewing a subscription.

As shown in FIG. 1, the company or entity that wishes to enroll its customers in a new service has accounts data for its customers that it stores in database 100. The accounts data includes customer data 110 that may include, for example, the accounts data for customers of the company or entity. Invitations 120 for enrolling in a new service are prepared and stored along with an invitee list 130 of those customers to which the new service is to be offered using the techniques of the invention. The invitations 120 are provided with the invitee list 130 and all or part of the customer data 110 to a communications platform 140 that is programmed to implement the methods described herein. Communications links between the company or entity and the communications platform 140 may be a wired connection including, for example, a USB connection, a Firewire connection, an Ethernet connection, or the like and/or a wireless connection such as wireless 802.11n connection, a radio connection, a cell phone connection, or the like. As will be appreciated by those skilled in the art, communications platform 140 may be a computer, a mainframe, a server, or the like. According to an example embodiment, communications platform 140 may include hardware components and/or software components such that communications platform 140 may be used to execute applications such as internet applications, operating systems, server applications, client applicants, database applications, or the like. For example, communications platform 140 may include a processor that is programmed to execute software that may invite a customer to enroll in a service by linking the customer's mobile phone number to an invitation and accepting a YES/NO response or other response including non-personal information that may link the customer to the customer's mobile phone number for enrolling in the offered service.

In an example embodiment, communications platform 140 includes a processor that may be in operative communication with a memory component. The processor may include a standardized processor, a specialized processor, a microprocessor, or the like. The processor may execute instructions including, for example, instructions for linking the customer's account information to an invitation and/or a mobile phone number, forwarding a service invitation to the customer, storing the customer's reply with the invitation to create an enrollment record, or any other suitable instruction, which will be described in more detail below.

Communications platform 140 may further include a memory component that may store the instructions that may be executed by the processor. The memory component may include a tangible computer readable storage medium in the form of volatile and/or nonvolatile memory such as random access memory (RAM), read only memory (ROM, cache, flash memory, a hard disk, or any other suitable storage component. In one embodiment, the memory component may be a separate component in communication with communications platform 140. According to another embodiment, the memory component may be integrated into the processor.

Communications platform 140 functions to link phone numbers in the customers' accounts data to invitations received from the company or entity for which customer data is stored in database 100. The company or entity may be a transaction partner, such as a corporation that has significant customer transactions; a communication partner, such as a corporation that may have incomplete electronic contact information; or a data partner, such as a company that has data that may be used to enhance an address profile. The customers for whom client data 110 is stored may be existing customers of the company, such as customers of a cell phone provider, an internet provider, a cable television provider, a utility company, a bank, or the like. Communications platform 140 enables the company to send invitations to these customers and to acquire their responses as acceptance/non-acceptance of the offered service. For example, communications platform 140 may enable a company, such as a utility company, to invite its customers to accept bills and service communications via SMS text messages.

Communications platform 140 captures the mobile phone numbers from the client data 110 provided by the company or entity 100 and, where such numbers are not available in the client data 110, accesses relay network 150 to acquire the mobile phone numbers, as possible, using the techniques described, for example, in U.S. patent application Ser. No. 12/709,312, filed Feb. 19, 2010. Communications platform 140 may include hardware components and/or software components such that relay network 150 may be used to authenticate a phone number. This may be done, for example, to determine whether the identified phone belongs to or is associated with a particular customer in the client data 110. Communications platform 140 then forwards opt-in invitations to all members of the invitee list 130 for whom mobile phone numbers are available and pre-linked by forwarding the opt-in invitations to an invitation adapter 160 that adapts the invitations for transmission. For example, if the invitations are to be sent via SMS text messages, then invitation adapter 160 may include n SMS aggregator 170. The service invitations are forwarded to the customer 180 via one or more of several possible communications media 170, including, for example, television, internet, radio, billboard, SMS text messaging, voice, mail, email, etc. The customer's consent to the offered service may be returned via one or more of these communications media as well. As an example, the opt-in invitation may include an SMS text message including a request for a YES/NO response to accept communications by SMS text message. The customer provides his/her YES/NO response as a reply SMS text message as evidence of his/her consent to the service or refusal of the service. The reply SMS text message is routed back to the communications platform 140 via one or more of the communications media 170 and invitation adapter 160. The captured reply including the customer's express consent/refusal is then adjoined to the client data 110 by communications platform 140 and/or a report of the customers' responses is prepared by the communication platform 140 and provided back to the company or entity. In this fashion, the company or entity may enlist the communication platform 140 to enroll its customers in the company's or entity's SMS text message communications service.

According to an example embodiment, communications platform 140 may include hardware components and/or software components that may be used to translate a received SMS text message into a different format. This may be done, for example, to translate an SMS text message into a format that may be easily understood by communications platform 140. For example, communications platform 140 may be in communication with several SMS text message providers. Each of the SMS text message providers may use a different format for sending and receiving text messages. To ensure that the text messages are normalized, invitation adapter 160 may include an SMS adapter (not shown) to translate text messages received from an SMS text message provider into a standardized format understood by communication platform 140 and communications media 170.

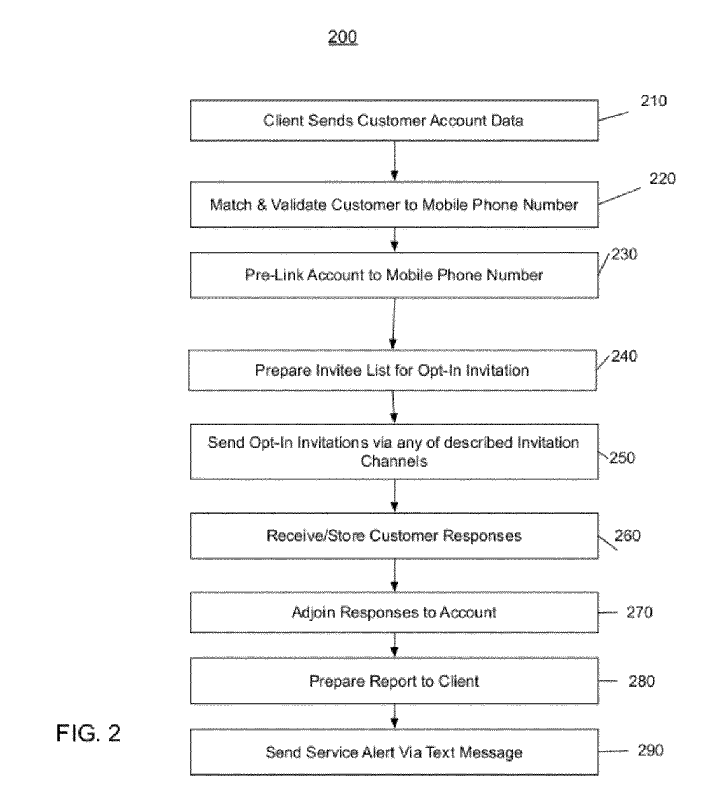

FIG. 2 illustrates an example embodiment of the service invitation method of the invention whereby the customer's mobile phone number is pre-linked to the customer's account information. As shown in FIG. 2, at 210 the client (a company or entity that desires to send a service invitation) sends its customer data 110 to communications platform 140. At 220, communications platform 140 matches and validates customers identified in the customer data 110 to mobile phone numbers for the respective customers. At 230, the customer data 110 is pre-linked to the identified mobile phone numbers for the respective customers. The invitee list 130 for the opt-in service invitations are prepared (or received) at 240 and used at 250 as addresses for the opt-in invitations. In an exemplary embodiment, the opt-in invitations may be transmitted using free to end user (FTEU) SMS text messages to that no cost is incurred by the customers for receiving an unsolicited opt-in invitation. At 260, the customers' responses to the opt-in invitations are received and stored and, at 270, adjoined to the accounts of the respective customers. The modified accounts and/or a report of the responses to the invitations may be provided to the company or entity at 280. Once the customer has opted into the offered service (e.g., service alerts via text messaging), then the service alert may be sent to the customer via SMS text message at 290.

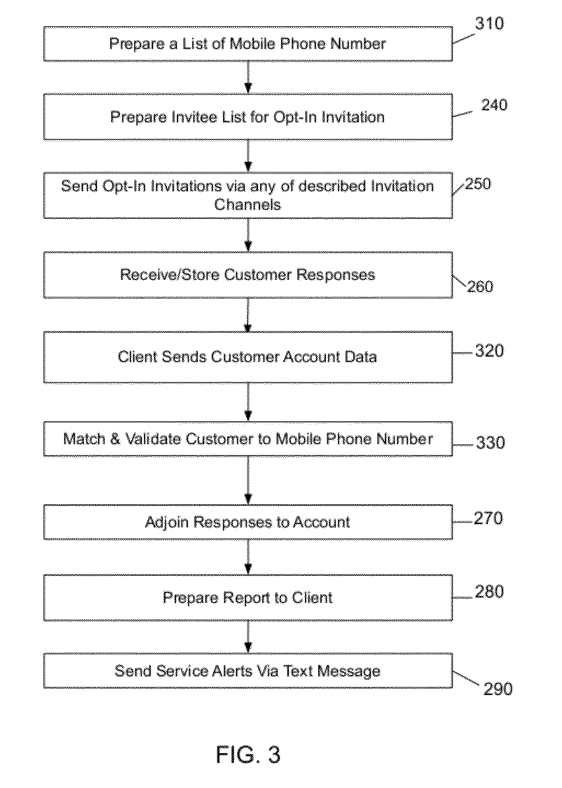

FIG. 3 illustrates an example embodiment of the service invitation method of the invention whereby the customer's mobile phone number is not known in advance and is linked to the customer's account information after the customer has replied to the service invitation. As shown in FIG. 3, at 310 a list of mobile phone numbers is generated and at 240 a list of invitees for the opt-in invitation is generated. The opt-in invitations are sent at 250 by one or more of the communications media. In an exemplary embodiment, the opt-in invitations are transmitted using free to end user (FTEU) SMS text messages to that no cost is incurred by the customers for receiving the unsolicited opt-in invitation. At 260, the customers' responses to the opt-in invitations are received and stored. At 320, the client sends the customer account data 110 to the communications platform 140 for matching and validating the customer and the customer responses to the mobile phone number used to send the response message at 330. If the customer is validated at 330, the mobile phone numbers are adjoined to the accounts of the respective customers at 270. The modified accounts and/or a report of the responses to the invitations may be provided to the company or entity at 280. Once the customer has opted into the offered service (e.g., service alerts via SMS text messaging), then the service alerts are sent to the customer at 290.

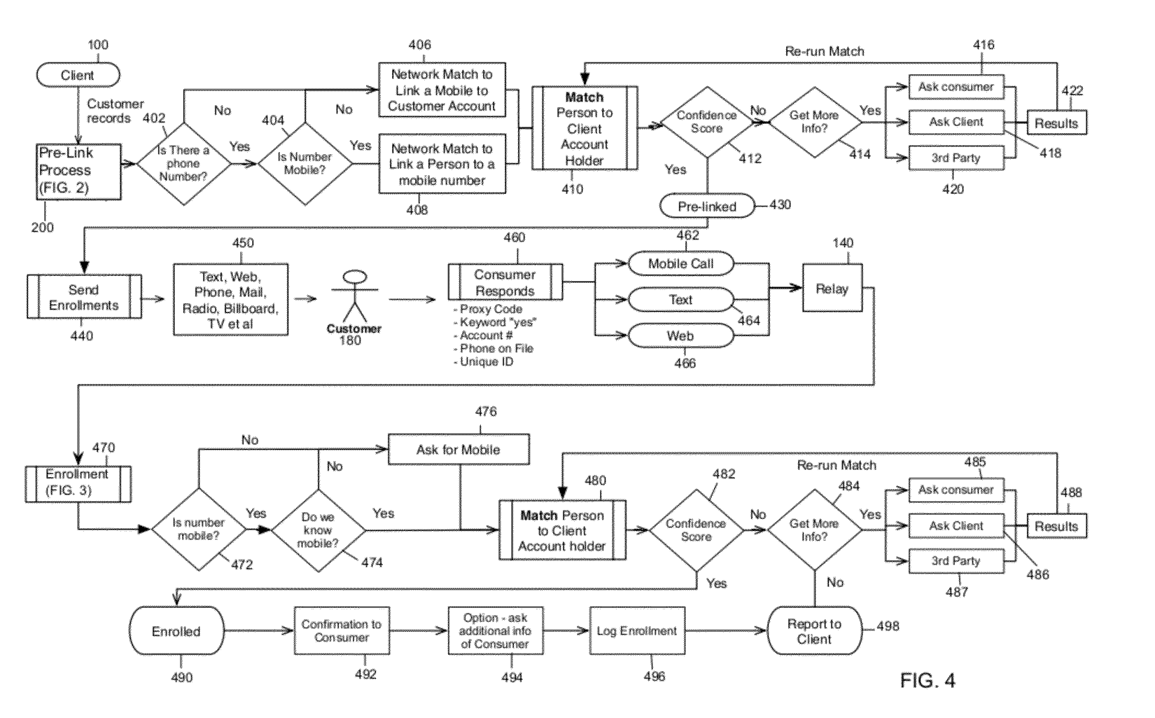

FIG. 4 illustrates an example embodiment of a system for enabling customers to enroll in a new service while providing limited personal information by pre-linking and/or post-linking the customer's mobile phone number to the customer's account information. As illustrated in FIG. 4, the client database 100 provides customer data 110 including, for example, CRS data and call logs, to the communications platform 140 for processing for pre-linking to account data as possible. The communications platform 140 determines at 402 if there is a phone number in the provided customer data 110 and, if so, determines at 404 if the number is a mobile number by, for example, comparing the number against a mobile number database. If the customer data 110 does not include a phone number for the customer, a network match is performed at 406 to link a mobile number to the customer's account. In addition, if the customer data 110 is determined at 404 to include a mobile number, the mobile number is network matched at 408 to link a person to the mobile number. These matching steps are preferably performed at 410 by matching the phone number to data provided in a database (not shown) using techniques described, for example, in U.S. patent application Ser. No. 12/709,312, filed Feb. 19, 2010. If a person match is found at 410 and the person matches the customer data with a sufficient level of confidence at 412 (e.g., with a high confidence score), then, at 430, the mobile phone number may be pre-linked to the customer's account for use in inviting the customer to participate in SMS text correspondence. On the other hand, if at 412 no match is found with sufficient confidence, then more information is gathered at 414 by sending inquiries to the customer at 416, the entity offering the service at 418, and/or a third party at 420. Any results to these inquiries ate gathered at 422 and provided back to the matching process to determine if a higher confidence score for matching the customer to an account may be obtained. This process may repeat until a match is found at 410 and a pre-link of the mobile phone number to the account data established at 430 to, for example, enable the customer to be invited to participate in SMS text message correspondence.

Once the customer data 110 is pre-linked to a mobile phone number at 430, or if it is desired to send the invitations without pre-linking, the client and/or the communications platform 140 prepares service enrollment invitations at 440 and sends the invitations to the customers over a suitable communications medium at 450. For example, the invitation may be sent to the customer via an SMS text message, the internet, email, phone, mail, radio, a billboard, television, and the like. In an exemplary embodiment, the invitation may include SMS text messages that ask the customer if he/she would agree to receive communications by SMS text message. The customer's response to this invitation is captured at 460. The customer may respond in any of a number of ways. For example, the customer may respond with a proxy code included in the invitation, a keyword such as “yes” or “no,” a partial account number, a phone number, a unique identifier, and the like. In accordance with the invention, this data provided by the customer is not personal to the customer and may be sent in the open. The response may be sent over any of a number of media including by mobile call at 462, an SMS text message at 464, and/or by an email or other web message at 466. The response is received at the communications platform 140 and logged with the corresponding mobile phone number and archived for later reference. The information is stored as evidence of enrollment as appropriate, and a report is prepared for the client, as appropriate, as when the client has requested the communications platform 140 to enroll the client's customers in a new service.

The customer's enrollment response 470 may also be post-linked to the customer's account data. Typically, this is not necessary if the mobile number has been pre-linked to the account data, but post-linking may also be required even in a case of pre-linked to account for customer responses over different media, such as an email response to an invitation sent as an SMS text message. For post-linking the enrollment response to customer account data, the communications platform 140 determines at 472 if a mobile phone number has been captured with the customer response, as when the customer replies by mobile phone. If so, communications platform 140 determines at 474 if the mobile number is known by, for example, comparing the number against a mobile number database. If the customer's mobile number is not provided with the customer's enrollment response, the customer may be asked for his/her mobile phone number at 476. Once the customer's mobile number has been acquired, a network match is performed at 480 to link the responding person to the customer's account. This matching step is preferably performed at 480 by matching the phone number to data provided in a database (not shown) using techniques described, for example, in U.S. patent application Ser. No. 12/709,312, filed Feb. 19, 2010. If a person match is found at 480 and the person matches the customer data with a sufficient level of confidence at 482 (e.g., with a high confidence score), then, at 490, the response is accepted and the responder is enrolled in the offered service. On the other hand, if at 482 no match is found with sufficient confidence, then more information is gathered at 484 by sending inquiries to the customer at 485, the entity offering the service at 486, and/or a third party at 487. Any results to these inquiries are gathered at 488 and provided back to the matching process 480 to determine if a higher confidence score for matching the customer to an account may be obtained. This process may repeat until a match is found at 480. Once the customer is enrolled at 490, confirmation of enrollment is sent to the customer at 492 and, optionally, additional information is requested at 494 to complete the enrollment records. The enrollment response is logged into a database at 496 and, as appropriate, a report is sent to the enrolling entity at 498.

Those skilled in the art will appreciate that the system of FIG. 4 may be used to send service enrollment invitations to existing customer as well as potential customers and enable such customers to respond with simple YES/NO answers to the enrollment inquiries. The pre-link and post-link processes may be used to tie these responses to the appropriate person and appropriate account for the enrollment process.

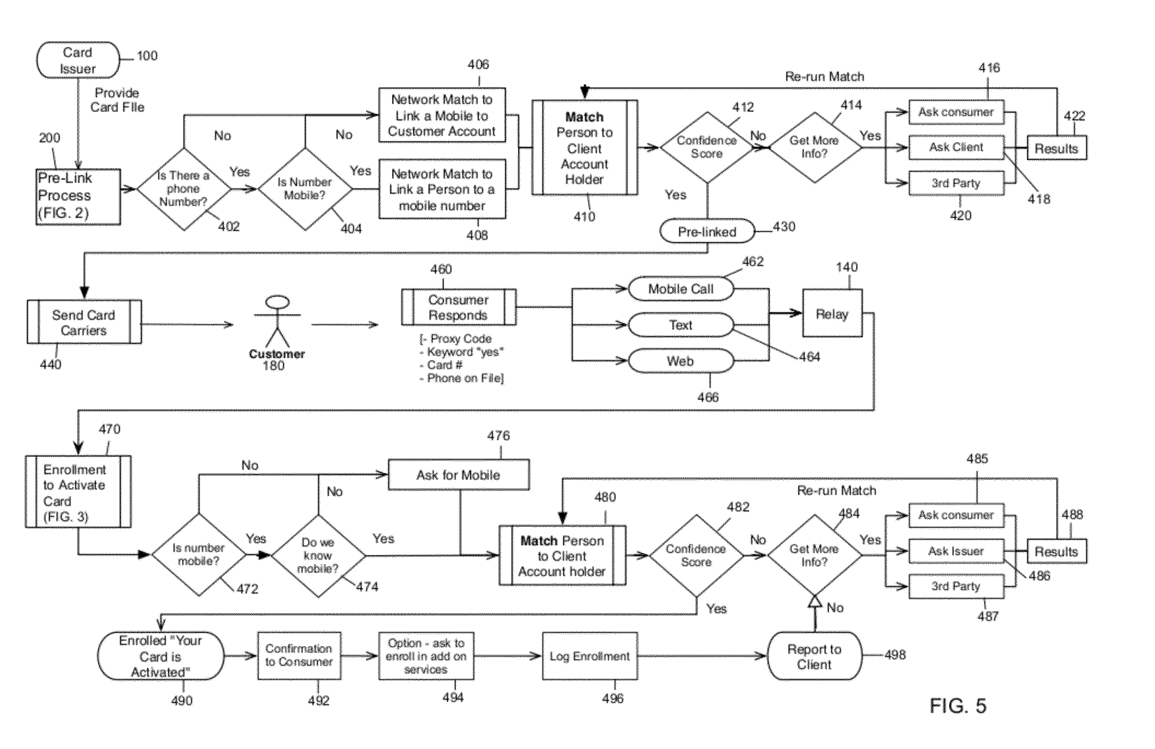

FIG. 5 illustrates an example embodiment of the enrollment and mobile activation of an account card whereby the card holder information is pre-linked, but does not include the card holder's mobile phone number. In this example, the customer may respond using his/her mobile phone number and the activation response post-linked to the customer's credit card account number using the post-linking process described above with respect to FIG. 4. In this example, the customer may activate the offered credit card using a phone other than that phone number already included in the customer's account. For example, the customer's landline number may be pre-linked to the enrollment offer, but the customer may respond to the enrollment offer using his/her mobile phone number provided that mobile phone number may be effectively post-linked with sufficient confidence to the customer to whom the enrollment offer was made. Also, since the customer is pre-linked, the customer need not respond with the credit card number and may respond from his/her mobile phone even if the mobile number was not known to the card issuing entity.

As a further example embodiment, the system of FIG. 4 may be used to enroll a customer in fraud alerts for a card account whereby the cardholder is not required to provide personally identifiable information. In this example, the customer may send a text message to an advertised enrollment short code including non-personal information including: (1) the customer service phone number on the back of the card; (2) that last four digits of the card; (3) and all or part of the customers last name. Upon receiving the enrollment request, the request and mobile number is logged. A post-link match is performed against the issuer's cardholder data to identify the corresponding account for enrollment. A confirmation text message may be sent out to the customer confirming the enrollment in fraud alerts and the card issuer may receive a report listing the successful and unsuccessful enrolled accounts.

Those skilled in the art will appreciate that if the customer's response to an enrollment inquiry does not match any of the client's pre-linked customer data that the communications platform 140 may conduct a third party query for information that can be used to identify the customer and his/her mobile number. If the customer is identified, the results are provided to the matching process for increasing the confidence score. If no third party query is conducted or no results are found, then it may be determined that this customer's account cannot be matched to a response to an invitation in accordance with the invention, and a report to that effect is generated at 498.

Those skilled in the art also will readily appreciate that many additional modifications are possible in the exemplary embodiment without materially departing from the novel teachings and advantages of the invention. For example, the system described herein may be used to allow a utility company to enroll its customers into an electronic billing system without requiring the utility company customers to provide electronic contact information. In one example embodiment, the utility company may have a database that includes physical addresses, account numbers, and names for its customers; however, the utility company does not have any electronic contact information for its customers. On the other hand, a cell phone company may have a server that includes the electronic contact information for the customers of the utility company. The techniques described herein may be used by the utility company to send its customers a text message asking them if they would like to receive electronic bills on their cell phone. The customers may response with simple YES/NO responses that are either linked to the customer data before the text message is sent or after the response is received. The utility company may then transmit electronic bills to the customers' cell phones. These embodiments and other similar embodiments are intended to be within the scope of the following claims.

What is claimed:

1. A method of enrolling a customer in a service offered by an entity, comprising the steps of:
linking an invitation to enroll in a service offered by the entity with a customer's mobile phone number;
presenting the invitation to the customer via a communications medium and instructing the customer to enroll from the customer's mobile phone; and
capturing the customer's response from the customer's mobile phone.

2. The method as in claim 1, wherein the invitation to enroll in the service is pre-linked to the customer's mobile phone number and the invitation elicits a yes or no confirmation response from the customer to enroll in the service.

3. The method as in claim 1, wherein said linking step comprises the steps of:
receiving customer data from the entity;
capturing or determining the customer's mobile phone number from the customer data; and
matching the captured or determined mobile phone number to a customer account of the customer.

4. The method as in claim 1, wherein capturing the customer's response includes the step of logging the customer's response into a database with the customer's mobile phone number.

5. The method as in claim 4, further comprising preparing and sending a report to the entity indicating which customers have agreed to enroll in the service.

6. The method as in claim 1, wherein the customer's response to the invitation is linked to the customer's accounts with the entity by identifying the customer who responded to the invitation and linking the responding customer to the customer's accounts.

7. The method as in claim 1, wherein the communications medium comprises at least one of radio, mail, billboard, television, telephone, email, web, and SMS text message.

8. The method as in claim 1, wherein the customer's response includes a telephone number, a partial account number, and all or part of the customer's name.

9. A system for enrolling a customer in a service offered by an entity, comprising:
a memory that stores computer executable instructions; and
a processor that processes the computer executable instructions to perform the steps of:
linking an invitation to enroll in a service offered by the entity with a customer's mobile phone number;
presenting the invitation to the customer via a communications medium and instructing the customer to enroll from the customer's mobile phone; and
capturing the customer's response from the customer's mobile phone.

10. The system as in claim 9, wherein the invitation to enroll in the service is pre-linked to the customer's mobile phone number and the invitation elicits a yes or no confirmation response from the customer to enroll in the service.

11. The system as in claim 9, wherein the processor is programmed to link the invitation to enroll in a service, prior to sending the invitation, to the customer's phone number by receiving customer data from the entity, capturing or determining the customer's mobile phone number from the customer data, and matching the captured or determined mobile phone number to a customer account of the customer.

12. The system as in claim 9, wherein the processor is further programmed to log the customer's response to the invitation into a database with the customer's mobile phone number.

13. The system as in claim 12, wherein the processor is further programmed to prepare and send a report to the entity indicating which customers have agreed to enroll in the service.

14. The system as in claim 9, wherein the processor links the customer's response to the invitation to the customer's accounts with the entity by identifying the customer who responded to the invitation and linking the responding customer to the customer's accounts.

15. The system as in claim 9, wherein the communications medium comprises at least one of radio, mail, billboard, television, telephone, email, web, and SMS text message.

16. The system as in claim 9, wherein the customer's response includes a telephone number, a partial account number, and all or part of the customer's name.
